(19) United States
(12) Patent Application Publication
(10) Pub. No.: US 2016/0303767 A1
(43) Pub. Date: Oct. 20, 2016

(54) BIODEGRADABLE THERMOPLASTIC MOULDING AND EXTRUSION COMPOUNDS MADE FROM BIOMASS

(71) Applicants: Kenneth Hillel Peter Harris, Asker (NO); Akshya Sharma, Baton Rouge, LA (US)

(72) Inventors: Kenneth Hillel Peter Harris, Asker (NO); Akshya Sharma, Baton Rouge, LA (US)

(21) Appl. No.: 15/133,528

(22) Filed: Apr. 20, 2016

Related U.S. Application Data
(60) Provisional application No. 62/150,160, filed on Apr. 20, 2015.

(51) Int. Cl. B29B 9/12; B29B 9/16; B29B 9/06; B29B 9/10

(52) U.S. Cl. CPC B29B 9/12; B29B 9/10; B29B 9/16; B29B 9/06; B29K 2001/00

(57) ABSTRACT

The present invention is directed to a method of making thermoplastic granulates. A comminuted biomass is mixed with a lignin swellant such that the content of substances soluble in diethyl ether is at least 3.0% and ground and processed in a compounding extruder equipped with compaction, heating, cooling venting and grinding zones to form thermoplastic dry blends and granulates.

### CROSS-REFERENCE TO RELATED APPLICATIONS

The present application claims the benefit under 35 U.S.C. §119(e) of U.S. Provisional application Ser. No. 62/150,160, filed Apr. 20, 2015, entitled “FULLY BIODEGRADABLE THERMOPLASTIC MOULDING AND EXTRUSION COMPOUNDS BASED UPON LIGNOCELLULOSIC BIOMASS”, which is hereby expressly incorporated herein in its entirety.

### FIELD OF THE DISCLOSURE

The present disclosure relates, in general, to biodegradable dry blends and granulates based upon lignocellulosic biomass that can be converted by typical thermoplastic processing methods to extruded and moulded products, foils, etc. having excellent dimensional stability and water resistance.

### BACKGROUND

The high price of fossil fuels and the worldwide interest in replacing fossil fuel-based materials by others based upon renewable resources, has led to a considerable interest in biomass conversion processes for the manufacture of products that can replace those based upon petrochemicals. One such area is the replacement of bulk thermoplastics such as polyethylene, polypropylene and polystyrene with biodegradable alternatives based upon biomass that can be processed by thermoplastic processing equipment.

Products are available which use polymerisable monomers made by the fermentation of biomass. Others are made using bioderived components for the partial replacement of petrochemicals.

These products suffer from the disadvantage of being relatively costly; few are fully biodegradable and even fewer are based 100% on renewable raw materials. Those that are, are less suitable for prolonged use, especially in outdoor and moist environments, so they are typically used for disposable items, e.g., packaging.

Another group of products are made by a steam treatment process that aims at breaking a biomass down to particles and substances that can act as binders. However, whereas these materials can be converted into molded products by compression, they are not free flowing thermoplastics in the normal sense of the word, meaning that they cannot be remelted and then shaped by an injection moulding machine, extruder or other typical thermoplastic processing equipment. This is due to the fact that they begin to crosslink when (re)heated, which causes their melt viscosity to increase and their ability to exhibit plastic flow to decrease. This in turn leads to more processing work being converted into heat which accelerates the crosslinking and binding process until the whole sets solid.

### SUMMARY OF THE DISCLOSURE

In one embodiment, a method for making biomass-based dry blends and granulates, suitable for conversion by typical equipment used to process thermoplastics, into moulded and extruded products having excellent dimensional stability and water resistance. A biomass containing at least 20% moisture is comminuted such that at least 90% of the particles are smaller than 25 mm. A lignin swellant is added, to produce a mixture, such that the content of substances soluble in diethyl ether in the mixture is at least 1.0 wt. % and preferably at least 8.0 wt. %. The mixture is processed in a compounding extruder equipped with compaction and heating zones capable of increasing its temperature to at least 160° C. during compaction whilst comminuting it to particles smaller than 1 mm. In another embodiment, the biomass is steam treated prior to being processed in the extruder, in which case the extrusion temperature may not need to be more than 125° C. The resultant product in each case is in the form of powder, or strands if a multiorifice die is used, that may need to be dried to less than 10% moisture content before use.

### DETAILED DESCRIPTION

Various embodiments of the presently described inventive concepts are directed toward biomass-based thermoplastic granulates and methods of making same. Broadly, at least one embodiment of the present disclosure is directed to a method of producing granulates suitable for moulding and extrusion. A size-reduced lignocellulosic biomass containing at least 20% moisture is mixed with a lignin swellant having a boiling point in excess of 100° C. such as vegetable oils or fatty acids to produce a biomass mixture such that its content of ether soluble materials is at least 3.0%. The lignin swellant is added, among other things, in order to plasticise the material being processed in the extruder. The mixture is heated whilst under compaction to at least 160° C. for at least 2 minutes in a compounding extruder equipped with venting, compaction and grinding zones. The resultant product, a powder or if a multiorifice die is used, extruded strands, can then be dried and used as a basis for a thermoplastic dry blend or as a basis for granulates or pellets made in a roller granulator or pellet mill.

In another embodiment, the biomass is first heated with steam in a batch or continuous reactor at a temperature of at least 145° C. for at least 2 but not more than 15 minutes following which a lignin swellant is added and the whole transferred to the extruder, as a result of which the temperature in the extruder can be reduced but not to below 125° C.

The product leaving the extruder will be in the form of a powder consisting of particles that for the most part that are smaller than 1 mm or, if a multiorifice die is used, strands. Volatile substances, such as water vapour, released during the heating process are removed through vents placed at correct intervals along the extruder.

In another embodiment, powders or strands are made by extruding a steam-treated biomass with, in one embodiment, less than 40% moisture containing at least 3.0% of substances having boiling points in excess of 100° C. that are soluble in diethyl ether, for example an oil product such as a fatty acid or vegetable oil. In one embodiment, the steam treated product is made by injecting steam of at least 160° C. into a previously evacuated vessel, containing a biomass, whose smallest dimension is less than 8 mm for at least 2 minutes.

The additive/biomass mixture can be compacted before treatment such that the bulk density of the resultant product is at least 300 kg/m³. In one embodiment, the compacted biomass is subjected to steam having a temperature of between 160° C. and 230° C. for a period of 2-15 minutes and, in one embodiment, between 2 and 5 minutes at 180-200° C. The steam treated biomass is ejected and can be processed by compaction or extrusion, either alone or together with a filler or an additional fibre source.

In order to further illustrate various embodiments of the present invention, the following examples are given. However, it is to be understood that the examples are for illustrative purposes only and are not to be construed as limiting the scope of the subject invention.

### EXAMPLE 1

Thermoplastic Dry Blend and Granulate by Direct Extrusion of Biomass
i) A clean softwood feed is size reduced, e.g. in a hammer mill, such that 95% of the particles pass through a 6 mm screen.
ii) The milled product is thoroughly mixed with 4% of canola oil, which behaves as a lignin swellant and plasticizing agent.
iii) The mixture is then conveyed to a compounding extruder and therein ground and heated under compaction to 180° C. and held whilst being compacted at this temperature for 90-120 seconds, whereupon it is discharged through a single or multiorifice die.
iv) The extruded material can then be dried to below 10% moisture content and if required, ground and mixed with additives such as a basic alkaline earth compound, fillers, pigments, lubricants and used as such or granulated for subsequent processing in a moulding machine or extruder.

### EXAMPLE 2

Thermoplastic Dry Blend and Granulate by Direct Extrusion of Steam Treated Wood
i) A clean hardwood feed is chipped such that 95% of the chips have a smallest dimension of less than 8 mm
ii) The chips are then introduced into a pressure vessel, which is evacuated to a pressure of less than 0.1 barA for at least 1 minute.
iii) Steam at 16 bar (gauge) pressure is introduced and the pressure held in the reactor for 3.5 minutes
iv) The steam treated material is ejected, comminuted as needed to ensure that at least 95% of the biomass passes through a 5 mm screen and mixed with 3% canola oil
v) The mixture is then conveyed to a compounding extruder and therein mixed, compacted and heated under pressure to 130° C., venting as needed and held at this temperature for 90-120 seconds, whereupon it is discharged through a single or multiorifice die.
vi) The extruded material can then be dried to below 10% moisture content and if required, ground and mixed with additives such as a basic alkaline earth filler, pigments, lubricants and used as such as a dry blend or granulated for subsequent processing in a moulding machine or extruder.
   Moulded biomass products made by these methods have typically the following properties:
Water absorption after 24 hours immersion: <7%
Moisture content: <5%
Vicat softening point, 1 kg load 95-130° C.

From the above description, it is clear that the present disclosure is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed.

What is claimed is:

1. A method of making biodegradable, mouldable and extrudable thermoplastic granulates and dry blends comprising the steps of:
a) providing a biomass containing at least 20% moisture wherein at least 90% of the particles are smaller than 25 mm;
b) adding from between 1.0 wt. % to 8.0 wt. % of a lignin swellant to form a mixture;
c) heating the mixture in a vented compounding extruder equipped to heat, cool, grind and compact, such that the temperature in the compaction zones is at least 125° C. and the residence time there at least 1 minute, to make treated particles smaller than 1 mm in size.
d) ejecting the extrudate through a die as a powder or through a multiorifice die plate as strands

2. The method of claim 1 wherein the lignin swellant is a phenol-or oil.

3. The method of claim 2 wherein the oil product is a biobased oil, wax or fat.

4. The method of claim 1 where the biomass is first steam treated in a batch or continuous reactor for between 1 and 12 minutes at between 140° C. and 200° C.

5. The method of claim 4 where the batch reactor is evacuated after the introduction of the biomass and before steam injection.

6. The method of claim 1 wherein the lignin swellant is added in the extruder itself.

7. The method of claim 1 further comprising the step of drying the extrudate to a moisture content of at least 2% but not more than 15%

8. The method of claim 7 further comprising the step of compacting the dried product to make pellets or a granulate e.g. in a roller compactor, tabletting machine or pellet mill.

9. The method of claim 8 further comprising the step of adding at least 0.5% and not more than 20% of a basic filler to the treated material before drying or after drying and prior to final compaction

10. The method of claim 9 where the basic filler can be a finely divided alkaline earth metal compound such as the oxide, hydroxide or carbonate of calcium or magnesium.

11. The method of 1.d) where the powder or strands that have been crushed to a powder are mixed with additives such as polymers, lubricants, pigments and/or fillers before being used as dry-blends or granulated.
